(19) United States
(12) Patent Application Publication
(10) Pub. No.: US 2022/0051293 A1
(43) Pub. Date: Feb. 17, 2022

(54) METHOD AND SYSTEM FOR PLAYING PROMOTION MEDIA CONTENT IN TELECOMMUNICATION NETWORK

(71) Applicant: Rajvir Singh JUNEJA, Gurgaon, Haryana (IN)

(72) Inventors: Rajender Kumar Nangia, New Delhi (IN); Rajvir Singh Juneja, Gurgaon (IN)

(21) Appl. No.: 17/276,151

(22) PCT Filed: Apr. 16, 2020
(86) PCT No.: PCT/IB2020/053600

§ 371 Date: Mar. 14, 2021

(30) Foreign Application Priority Data
Apr. 16, 2019 (IN) 201911015162

(51) Int. Cl. G06Q 30/02; H04M 3/42; H04M 3/02

(52) U.S. Cl. CPC G06Q 30/0267; H04W 80/12; H04M 3/02; H04M 3/42017

(57) ABSTRACT

A method of playing promotion media content in a telecommunication network is disclosed. The method involves storing a plurality of promotion media content on a database (102) of WAP server (100). The method further includes receiving promotion media content on a memory unit of caller device (400) and callee device (500). Further, the method is followed by receiving incoming call signals from the caller device (400). The method further includes outputting the promotion media content by a predefined application on the devices (400), (500). The media content is played when the device (400) commencing a call to the device (500), during telephonic conversation between the device (400) and the device (500), and after disconnecting of the call between the devices (400), (500), by detecting at least one signal from plurality of telephony signals via signal detecting module (260) on a screen of at least one device (400) or device (500).

This application claims benefit of provisional application number 201911015162 filed on 16 Apr. 2019

### FIELD OF THE INVENTION

The present invention relates to providing promotion media content in a telecommunication network. More specifically, the present invention discloses a method and system of playing promotion media in a telecommunication network comprising plurality of mobile communication terminals by plurality of telephony signals.

### BACKGROUND OF THE INVENTION

In this advance era, uses of mobile phones are very common. The mobile phone is an extremely personal device. Today, mobile phones can be utilized for much more than just making and receiving calls. Most commonly, each and every individual is known about the use of mobiles.

Further, people are aware of uses and services that are provided through mobile phones. A mobile phone also known as a caller device, hand phone, wireless phone, cell phones or cellular phone used for data communication over a network. Mobiles are running via mobile communication terminals. This terminal also supports multimedia communication including images and videos, as well as data communications including symbols, numbers and characters.

On the other hand, product suppliers these days carry out numerous advertisements, i.e., non-personal information providing activities, for the promotion of the sales of the goods and the enhancement of public relations. While traditional advertisement media include television and radio broadcasting, newspapers, and magazines, banner advertisements or insertion advertisements in Internet contents are prevailing nowadays. In particular, short message advertisements utilizing the short message service (herein below, referred to as “SMS”) is emerging as a new advertisement medium recently.

However, the short message advertisement may have some limitations in the advertisement effect. First, a short message transmitted through the SMS is so short that the advertisement sponsor cannot express the message in detail.

More basically, since the mobile terminal is an apparatus mainly targeted for personal communication, most users are not interested in junk messages such as the advertisement short messages and likely to delete the messages just after the receipt of the messages. Considering that most advertisement short messages are directed for sales promotion of goods, such phenomenon may disappoint the sponsors.

With the development of high-quality mobile communication terminals, a mobile communication base station provides not only a voice communication service but also various contents such as stock, weather, sports, entertainment and current events, etc. With the increase in terminal usage time and frequency, service providers have sought a method of providing advertisements through the mobile communication terminal

Further, it has been found that these days more and more mobile phone users prefer to have conversations over their speaker phones. In other words, they like to talk to other users by using the microphone and speaker of mobile phones while multi tasking other activities, like working, doing daily chores, diving etc. In such a scenario, there is a need to provide advertisement in a telecommunication network, wherein advertisements could be pushed on mobile phones at the moment when users are conversing on mobile phones through speaker phones.

A French patent publication 2906956 discloses the method involves adding advanced functionality such as audience measurement, implementing an Internet network (140), to an advertisement or complementary contextual digital content, for constituting a set of files such as metafile, containing the content and advanced functionality information such (15) as link towards internet server (150). The set of the files is transmitted to a communication mobile terminal (110). The advanced functionality represented by the information and implementing the network is partially executed in the case of access of the content by a user of the terminal.

The US patent application 2008008295 discloses a system and method of providing advertisements to telephones and mobile phones during the set up of a call connection in a program controlled telephone exchange system includes the following steps: (1) storing advertisements corresponding to profiles for various phone users; (2) 30 providing the advertisement feeds upon the consent of the phone call initiator over the phone when requested by the telephone exchange; (3) identifying the (4) caller and selecting a suitable advertisement from on-line/off-line server; and (4) connecting the on-line server import source to an internet site and an output source to the telephone exchange via advertisement and playback circuit.

Another patent application WO/2001/037527 describes a system of converting phone signals having a signal converter. The system of converting telephone signals including a ring back tone signal, a busy tone signal and a network busy tone signal to a sound and/or a moving picture including an advertisement, a music, a message, or an English conversation. The system further discloses a user terminal outputting the sound and/or moving pictures including the advertisement, the music, the message or the English conversation instead of the telephone signal including the ring back tone signal, the busy tone signal, and the network busy tone signal.

Further, the system includes a server providing the sound an/or the moving picture including the advertisement, the music, the message and the English conversation. The system further includes a signal converter that stores the sound and/or the moving picture including the advertisement, the music, the message or the English conversation provided by the server, detects the telephone signal including the ring back tone signal, the busy tone signal and network busy tone signal, and converts the detected telephone signal to the sound and/or the moving picture in order to transmit to the user terminal.

The patent disclosed by our applicant with a domestic application no. 465/DEL/2009. The said patent describes promotion media content is played only when the user is commencing a call to another user. Further, the signals are capture via the mobile switch center during the outgoing call and incoming call.

The other patent disclosed by our applicant with a domestic application no. 1019/DEL/2008. The said patent describes that advertisement is played via ring tone. Further, the signals are capture via the mobile switch center during the outgoing call and incoming call.

The other patent disclosed by our applicant with a domestic application no. 1388/DEL/2008. The said patent is providing an advertisement using a caller tone of ringing sounds of a mobile phone terminal. Further, the signals are capture via the mobile switch center during the outgoing call and incoming call.

Therefore, a method and a system for promotion media content in a telecommunication network is required which may overcome above discussed drawbacks and provide easy to operate and a cost-effective method.

### SUMMARY OF THE INVENTION

To solve the above problems it is an object of the present invention to provide a method and system for playing promotion media content by call rings signals.

In an aspect of the present invention, a method of playing promotion media content in a telecommunication network comprising plurality of mobile communication terminals is disclosed. The said network includes a caller device and a calling device.

The said method involves storing a plurality of promotion media content on a database of a Wireless application protocol (WAP) server. The method further includes receiving said promotion media content on a memory unit of the caller device and the callee device.

Further, the said method is followed by receiving incoming call signals from the caller device. Wherein, said incoming call signals being generated by dialing the callee number. At last the method includes outputting the said promotion media content by a predefined application on the said caller device and the said callee device.

In an embodiment of the present invention, the said predefined application indicates a situation when the promotion media content is to be played. In one embodiment the said situation is the caller device commencing a call to the said callee device. In another embodiment, the said situation is during telephonic conversation between the said caller device and the said callee device. In yet another embodiment, is after disconnecting of the said call between the said caller device and the said callee device.

In an embodiment of the present invention, the said promotion media content is being played by detecting at least one signal from plurality of telephony signals via a signal detecting module on a screen of the at least one caller device or callee device.

In one embodiment of the present invention, the said promotion media content is played by utilizing incoming call ring signal comprises. The said method includes activating incoming call ring signal detecting module. The method is followed by capturing the said incoming call ring signal. Further, the method involves playing the said promotion media content via playing module in the callee device of the user.

In another embodiment of the present invention, the said promotion media content is played by utilizing outgoing call ring signal. The said method includes activating outgoing call ring signal detecting module. The said method is followed by identifying the said outgoing call ring signal.

Further, the said method involves capturing the said outgoing call ring signal. The said method further involves by transferring the said call through mobile switch center (MSC). The said method is followed by receiving the said outgoing call ring signal via receiving module, and playing the said promotion media content via the said playing module in the caller device during the said telephonic conversation between the users.

In one embodiment of the present invention, the said promotion media content is selected from at least one of video, audio message, screen saver, scrolling text, multimedia, background music, video, and display banners.

In one embodiment of the present invention, the said method further includes identifying a plurality of information. The said plurality of information includes information of the users, the promotion media content, updated promotion media status of the caller device and the callee device, and time of usage of the said promotion media content of each of the caller device and the callee device.

In one embodiment of the present invention, the method further includes updating a location of at least one of service or product via location signal module in a predefined radius in relation with the user. The said at least one of service or product is selected by the user and the said at least one of service or product is related to the promotion media content.

In one embodiment of the present invention, the said method further includes unlocking the said device via unlock module. The said devices are unlocked for playing the said promotion media content on the said devices.

In one embodiment of the present invention, the said method further includes uploading details of the said promotion media content played in the devices. The said details of the said promotion media content is uploaded in the said database via internet connection.

In one embodiment of the present invention, the said receiving of incoming call signals from the caller device includes capturing Caller Line Identity (CLI) of the caller device and predetermined service number via call action module of a call handler. The said method further includes scanning the said database via look up module.

Further, the said method includes retrieving the said plurality of information of the said database via the said look up module, and forwarding the said at least one information of the said plurality of information to the caller device via forwarding module.

In one embodiment of the present invention, the said promotion media content is being customized via a customization module. The said promotion media content is based on a captured signal of the caller device and the callee device.

In other aspect of the present invention, a system for playing promotion media content in a telecommunication network comprising plurality of mobile communication terminals is disclosed. The said system includes a Wireless application protocol (WAP) server having a database adapted to store plurality of promotion media content. The said system further includes a predefined application downloaded on a caller device and a callee device.

Further, the said predefined application is adapted to receive the said promotion media content in a memory unit associated with the said predefined application from the said database of the said WAP server. The said system further adapted to output said promotion media content on the said caller device and the callee device.

In the embodiment of the present invention, the said predefined application indicates a situation when the promotion media content is to be played. Accordingly, the said situation being the caller device commencing a call to the said callee device, during telephonic conversation between the said caller device and the said callee device, and after disconnecting of the said call between the said caller device and the said callee device.

In the said embodiment of the present invention, the said promotion media content is being played by detecting at least one signal from plurality of telephony signals via a signal detecting module.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### DESCRIPTION OF THE DRAWINGS

The advantages and features of the present invention will become better understood with reference to the following detailed description taken in conjunction with the accompanying drawings, in which:

A method and system for playing promotion media content is explained with reference to FIG. 1-FIG. 7.

FIG. 1 illustrates a flow chart depicting an exemplary method for playing promotion media content in a telecommunication network, according to various embodiments of the present invention;

FIG. 2 illustrates an exemplary block diagram representing system of playing promotion media content in a telecommunication network, according to various embodiments of the present invention;

FIG. 3 illustrates the exemplary method for playing promotion media content in a telecommunication network via detecting incoming call ring signal, according to various embodiments of the present invention;

FIG. 4 illustrates the exemplary method for playing promotion media content in a telecommunication network via detecting outgoing call ring signal, according to various embodiments of the present invention;

FIG. 5 illustrates a schematic diagram representing system of playing promotion media content in a telecommunication network, when caller device commencing a call to callee device, according to various embodiments of the present invention;

FIG. 6 illustrates a schematic diagram representing system of playing promotion media content in a telecommunication network, when the caller deice is in telephonic conversation with the callee device, according to various embodiment of the present invention; and

FIG. 7 illustrates a schematic diagram representing system of playing promotion media content in a telecommunication network, after disconnecting the call between the caller device and the callee device, according to various embodiment of the present invention; and

FIG. 8 illustrates a schematic diagram representing system of live survey and feedback via caller device/callee device in a telecommunication network, according to various embodiment of the present invention.

Like numerals denote like elements throughout the figures.

### DESCRIPTION OF THE INVENTION

The exemplary embodiments described herein detail for illustrative purposes are subjected to many variations. It should be emphasized, however, that the present invention is not limited to a method and system of playing promotion media content mobile communication terminals in a telecommunication network by utilizing plurality of telephony signals. It is understood that various omissions and substitutions of equivalents are contemplated as circumstances may suggest or render expedient, but these are intended to cover the application or implementation without departing from the spirit or scope of the present invention.

Unless otherwise specified, the terms, which are used in the specification and claims, have the meanings commonly used in the field of system for producing coke and process involved therein. Specifically, the following terms have the meanings indicated below.

The terms “a” and “an” herein do not denote a limitation of quantity, but rather denote the presence of at least one of the referenced items.

The terms “having”, “comprising”, “including”, and variations thereof signify the presence of a component.

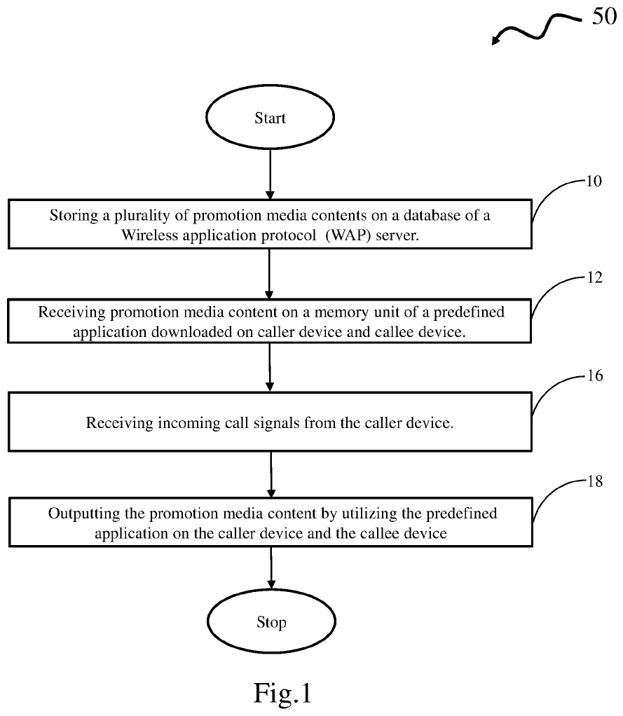

As shown in Figures, and especially FIGS. 1 & 2, a method (50) of playing promotion media in a telecommunication network comprises a plurality of mobile communication terminals. The said method is explained with reference with the flowchart.

Referring to FIG. 1, at step (10), the said method (50) involves storing plurality of promotion media contents on a database (102) of a Wireless application protocol (WAP) server (100).

In one embodiment of the present invention, the said plurality of promotion media contents includes customized video caller tone, video ring back tone, video ring tone, pre-call video, fixed wallpaper, sliding wallpaper, audio message, screen saver, scrolling text, multimedia, background music, display banners, mobile key pad or location based service (LBS). However, it should be understood that such examples should not be construed as a limitation to the present invention.

In another embodiment of the present invention, the said database (102) of the said WAP server (100) includes plurality of information.

The said plurality of information includes information of the users, the information related to promotion media contents, updated promotion media status of the users, time of usage of the said promotion media of each user (refer FIG. 1).

At step (12), the said method (50) further involves receiving said promotion media content on a memory unit (302) of a predefined application (300) downloaded on caller device (400) and callee device (500). The said predefined application (300) is in communication with the said database (102) of the WAP server (100) (refer FIG. 1).

At step (14), the said method (50) further involves receiving incoming call signals from the caller device (400), the said incoming call signals are generated by dialing a callee number (refer FIG. 1).

In the said embodiment of the present invention, the said incoming call signals are generated in the callee device (500).

Further, at step (16), the method involves (50) outputting the said promotion media content by the said predefined application on the said caller device (400) and the said callee device (500) (refer FIG. 1). In an embodiment, the outputting of the said promotional media is on a screen of the at least one caller device (400) or callee device (500).

In the embodiment, the said predefined application (300) is being indicating a situation when the promotion media content is to be played.

In one embodiment, the said situation being the caller device (400) commencing a call to the said callee device (500).

In another embodiment, the situation being during telephonic conversation between the said caller device (400) and the said callee device (500).

In another embodiment, the situation being after disconnecting of the said call between the said caller device (400) and the said callee device (500).

In the embodiment, the said promotion media content is played by detecting at least one signal from the said plurality of telephony signals via signal detecting module (260).

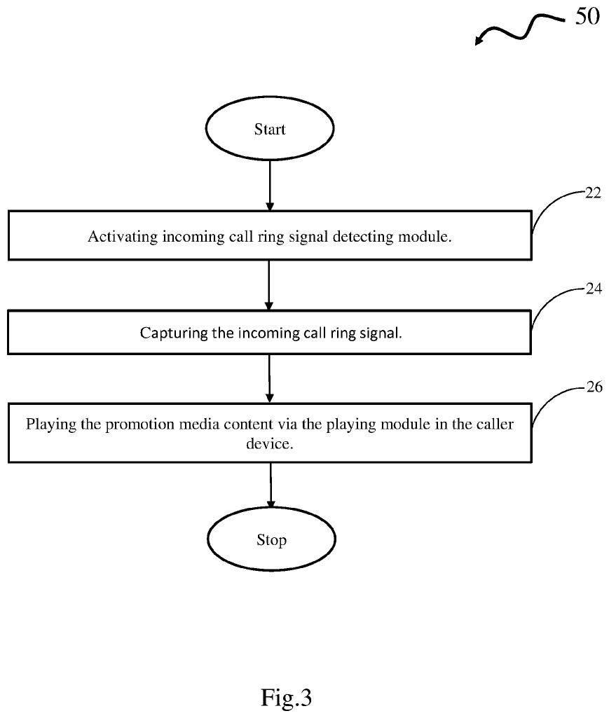

In one embodiment, the said method (50) involves playing the said promotion media content by utilizing incoming call ring signal (refer FIG. 3).

As shown in FIG. 3, at step (22), the said method (50) includes activating of incoming call ring signal module (270).

Further, at step (24), the said method (50) includes capturing the said incoming call ring signal via the said incoming call ring signal module (270).

The said method follows with next step (26), the step (26) includes playing the said promotion media content via playing module (290) in the caller device (400) of the user (refer FIG. 3).

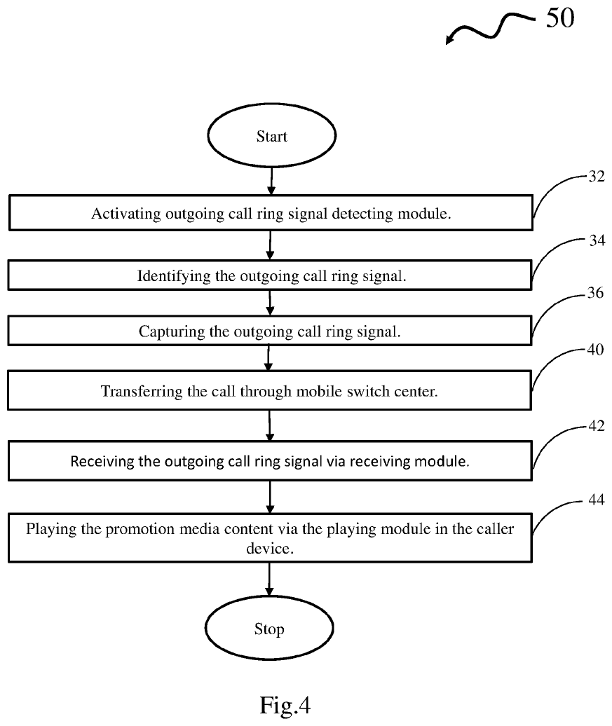

In another embodiment, the said method (50) involves playing the said promotion media content by utilizing outgoing call ring signal (refer FIG. 4).

At step (32), the said method (50) involves activating outgoing call ring signal detecting module (280). The said outgoing call ring signal detecting module (280) waits till a telecom operator connects call to the callee device (500) (refer FIG. 4).

Further, at step (34), the said method (50) involves identifying the said outgoing call ring signal.

The said method continues with step (36), the said method includes capturing the said outgoing call ring signal.

At step (38), the method (50) involves transferring the said call through mobile switch center (MSC) (320) (refer FIG. 4).

Further at step (42), the method (50) involves receiving the said outgoing call ring signal via receiving module.

Furthermore, at step (44), the method (50) involves playing the said promotion media content via the said playing module (290) in the caller device (400) (refer FIG. 4).

In one embodiment, the said promotion media is customized caller tune (CCT). Accordingly, the said user may be able to hear particular CCT, like advertisement, mantra, dialogue, songs, movie and trailers on particular number in the customized format.

Further, if any particular CCT likes any specific advertisement, song, dialogue, mantra, movie, trailer etc. are not available in the marketplace then in that case user can download this ring tone and convert it into CCT (Customized Caller Tone) by pressing # (hash) or any specific key. Instead of it, anyone can change any CCT to ring tone.

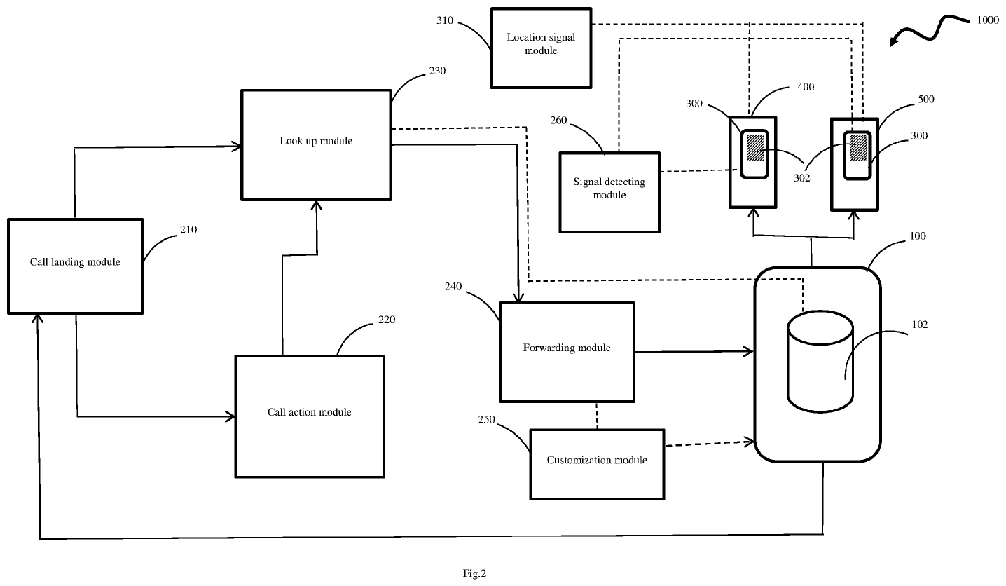

In another embodiment of the present invention, the said promotion media content is Customized Caller video Tune (CCVT). Accordingly, the said promotion media content is customized via customization module (250). In addition, the said promotion media content is based on a captured signal of the caller device (400) ((refer FIG. 2).

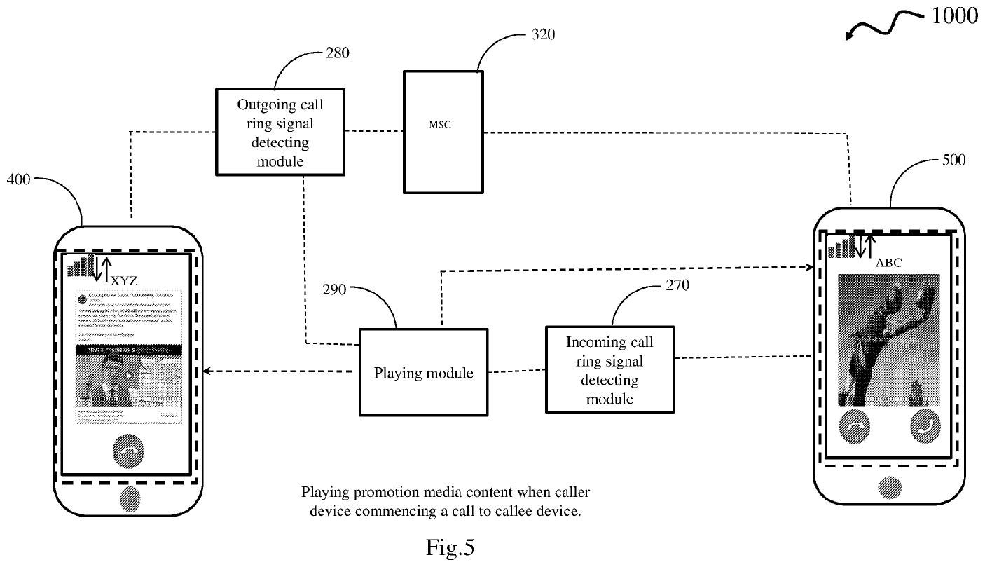

In the embodiment of the present invention, as shown in FIG. 5, when the user of the caller device (400) is commencing a call to the callee device (500) of another user, both the user of the caller device (400) and the callee device (500) are registered members. Accordingly, the customized promotion media content will play on both the caller device (400) and the callee device (500) during the ringing phase.

In the said embodiment of the present invention, the said outgoing call signal detecting module activates to capture the outgoing call ring signal from the caller device (400).

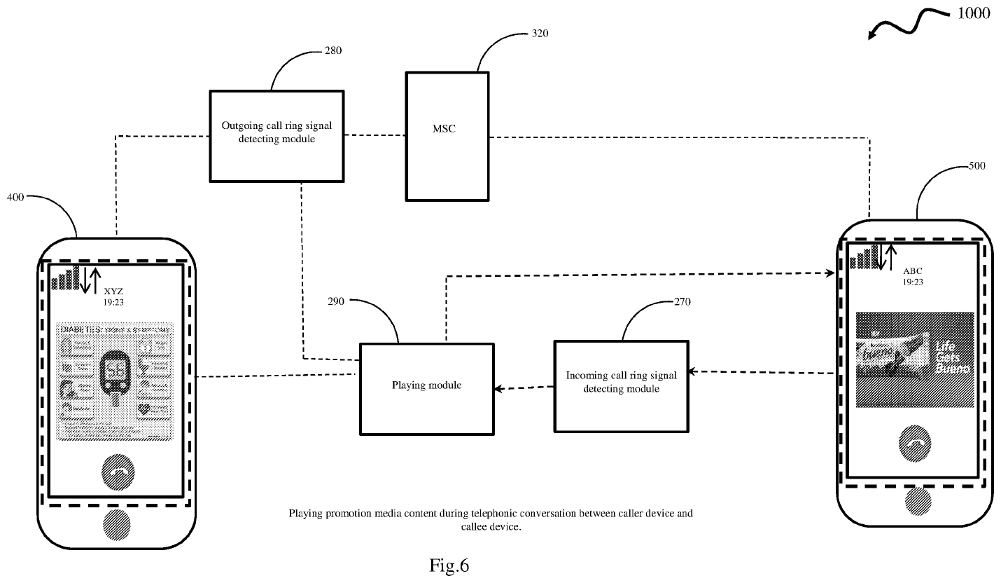

In another embodiment of the present invention, when the user of the callee device (500) receives the call and start the conversation with the user of caller device (400), the said playing module (290) of the said predefined application (300) activates to play the said promotion media content on both the caller device (400) and callee device (500) (refer FIG. 6).

In the embodiment of the present invention, the said promotion media content played during the telephonic conversation between the caller device (400) and the callee device (500) is different from the promotion media content that is played during the ringing phase (refer FIG. 6).

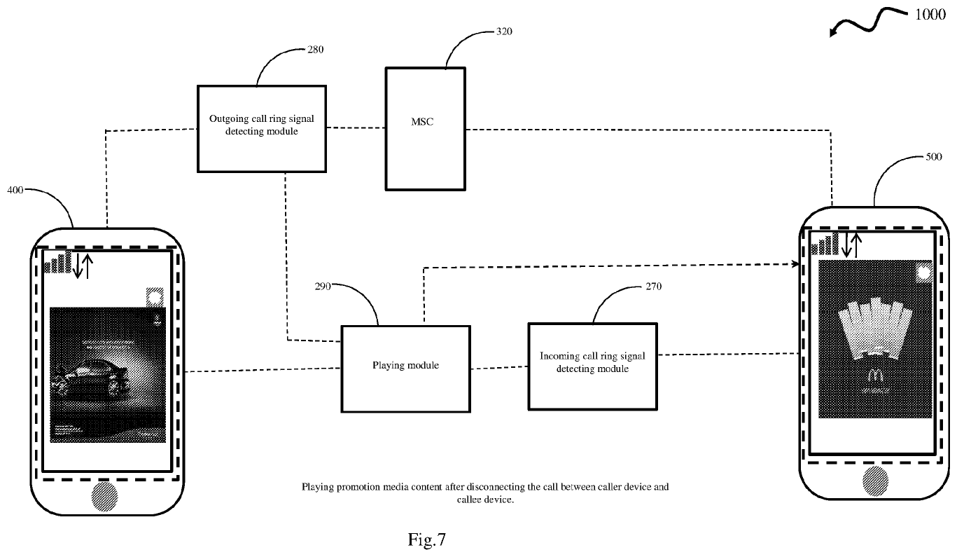

In one embodiment of the present invention, when any of the user of caller device (400) or callee device (500) disconnects the call, the said promotion media content is played on both the devices (400), (500) (refer FIG. 7).

In the said embodiment of the present invention, the said promotion media content played is different from the promotion media content that is played in above embodiments.

In an embodiment, the said promotional media content may be played by outputting on a screen of the at least one caller device (400) or callee device (500). In another embodiment, the outputting is when the at least one caller device (400) or callee device (500) is in speaker mode.

In one embodiment of the present invention, when the registered user gets a call from the another user, and the said registered user rejects the call than the signal disconnected mode run the said promotion media content on the screen of the register user. Further, if call is disconnected by the said another user than also the signal disconnected mode run the said promotion media content on the screen of the register user.

In another embodiment of the present invention, when the registered user disconnect call after telephonic conversation than also the signal disconnected mode run the said promotion media content on the screen of the register user.

In yet another embodiment of the present invention, when the registered user commencing the call to another user. The said promotion media content with or without sound will be played till the user from receiving side receives or rejects the call.

In the said embodiment, when the user of receiving side receives the call than the said promotion media content will be played without sound during telephonic conversation.

In the said embodiment, when the user of receiving side rejects the call than the said promotion media content will be played with or without sound.

In one embodiment of the present invention, the the Customized Caller video Tune (CCVT) the caller may select different videos for different numbers.

In one embodiment of the present invention, the said method (50) further includes updating a location of at least one of service or product via location signal module (310). The said location is updated when the said at least one of service or product comes in predefined radius in relation with the user. The said at least one of service or product is selected by the user and the said at least one of service or product is related to the promotion media content (refer FIG. 2).

Further, the location will also give its name and contact number and other details, as soon as the user visits that place and will come out of there, the user will receive updates via various means, whether or not he needs it or not. The user will also take feedback.

In one embodiment of the present invention, the said method (50) includes upload details of the promotion media content played in the devices (400), (500). The said details of the said promotion media content is uploaded in the said data base (102) via internet connection

FIG. 2 illustrates an exemplary block diagram of a system (1000) for playing promotion media content in a telecommunication network comprising plurality of mobile communication terminals. The said system (1000) includes a Wireless application protocol (WAP) server having a database (102) adapted to store plurality of promotion media content. The said system further includes a predefined application (300) downloaded on a caller device (400) and a callee device (500).

Further, the said predefined application (300) is adapted to receive the said promotion media content in a memory unit (302) associated with the said predefined application (300) from the said database (102) of the said WAP server (100). The said predefined application further adapted to output said promotion media content on the said caller device (400) and the callee device (500).

In the embodiment of the present invention, the said predefined application (300) indicates a situation when the promotion media content is to be played. Accordingly, the said situation being the caller device (400) commencing a call to the said callee device (500), during telephonic conversation between the said caller device (400) and the said callee device (500), and after disconnecting of the said call between the said caller device (400) and the said callee device (500).

In the said embodiment of the present invention, the said promotion media content is being played by detecting at least one signal from plurality of telephony signals via a signal detecting module (260).

In one embodiment of the present invention, the said system (1000) includes an incoming call ring signal detecting module (270) adapted to detect incoming call ring signal. The said detection of the said incoming call ring signal is utilized to play the said promotion media content via playing module (290) in the said callee device (500) of the user (refer FIG. 2).

In another embodiment of the present invention, as shown in FIG. 2, the said system (1000) further includes an outgoing call ring signal detecting module (280) adapted to detect outgoing call ring signal. The detection of the said outgoing call ring signal is utilized to play the said promotion media content via the said playing module (290) in the said caller device (400) of the user.

In another embodiment of the present invention, the said system (1000) further includes a customization module (250) for customizing the said promotion media content. The said promotion media content is based on a captured signal of the caller device (400) and the callee device (500) (refer FIG. 2).

In one embodiment of the present invention, the said system (1000) includes a call landing module (210) adapted to receive incoming call signals from a caller device (400). The said incoming call signals are generated by dialing a predetermined service number on the caller device (400).

In the said embodiment, the term incoming call as mentioned herein may refer to “phone call requests’ originating from the caller device (400).

Further, said call handler includes call action module (220) adapted to capture Calling Line Identity (CLI) of the caller device (400) and the said predetermined service number. The said call action module (220) is communicably connected to the said call landing module (210) (refer FIG. 2).

In one embodiment, the call action module (220) is further adapted to perform an action on incoming call that enables service providers to derive monetary benefit while providing a providing content or information over the communication network.

Further, the call handler includes look up module (230) adapted to scan the said database (102) and retrieve the said plurality of information (refer FIG. 2).

In the embodiment of the present invention, the said look up module (230) further configured to identify information, content, one or more services, or tasks to be provided based on the identified caller IDs.

The said call handler further includes forwarding module (240) communicably connected to the said look up module (230). The said forwarding module (240) is adapted to at least one information of the said plurality of information to the caller device (400) (refer FIG. 2).

In one embodiment of the present invention, the at least one information is selected from at least information of the users, the information related to promotion media contents, updated promotion media status of the users, time of usage of the said promotion media of each user.

In one embodiment of the present invention, devices (400), (500) connect to the system (1000) through a missed call service, sms and the like. Subsequently, the system (100) send a link of Uniform Resource Locator (URL) to the said devices (400), (500), and the user has to download and install the said predefined application on the said devices (400), (500).

In one embodiment of the present invention, the said system (1000) further includes location signal module (310) adapted to update a location of at least one of service or product in a predefined radius in relation with the user. The said at least one of service or product is selected by the user, and the said at least one of service or product is related to the promotion media content (refer FIG. 2).

In one embodiment of the present invention, the system (1000) includes unlock module adapted to unlock the caller device (400) of the user. The said devices (400), (500) are unlocked to play the said promotion media content on the said devices (400), (500).

In one embodiment of the present invention, the system (1000) further includes auto mobile operating module adapted to operate the said devices (400), (500) by any other personal computer or mobile phone.

In one embodiment of present invention, while communicating between two members of Ad caller ring back tone “CRBT”, if the receiver's “caller ring back tone” matches with caller's profile than the caller will hear “caller ring back tone (ad Jingle)” which matched with his profile instead of default random “caller ring back tone”. In case of matching profile, it will not run randomly else if the receiver's “Caller ring back tone” does not match with the caller's profile, then it will play randomly. Here it is necessary that receiver must have enabled the CRBT.

Example

| | Enabled | | Caller will Hear |
|---|---|---|---|
| Caller | CRBT | Receiver | CRBT |
| 1 | AA | XYX | AA |
| 2 | AB | XYX | AB |
| 3 | AC | XYX | AC |
| 4 | AD | XYX | AD |
| 5 | AE | XYX | AE |
| 6 | AF | XYX | AF |
| 7 | AG | XYX | AG/AB |

In the said exemplary embodiment of the present invention, the Caller (7) and receiver (7) are the members of Ad CRBT and remains are not, and receiver has selected AA, AB, AC, AD, AE, AF and AG as caller ring back tones for callers. While communicating Caller (7) and receiver the caller ring back tone AB will be played instead of AG because it match with Caller 7's profile.

In one embodiment of the present invention, as soon the promotion media content is forwarded to the devices (400), (500) from the server (100), the user does not need internet to play the said promotion media content.

In one embodiment of the present invention, the said system (1000) further includes a speaker and loudspeaker sound controlling module. The said speaker and loudspeaker sound controlling module is adapted to capture the incoming or outgoing rings via the predetermined command to reduce or increase the ring tone sound of speaker and loudspeaker.

In one embodiment of the present invention, the system (1000) further includes incoming call sound controlling module. In the embodiment, when the call of the caller device (400) and the callee device (500) connects than the sound of caller device (400) with respect to callee device (500) may be controlled by the said incoming call sound controlling module and vice versa.

In one embodiment of the present invention, the said system (1000) further includes sound capturing and control module. The said module is adapted to capture the sound coming from predetermined range through a mike.

In one embodiment of the present invention, the said system (1000) further includes analysis module. The analysis module is adapted to incoming calls, outgoing calls, sms, mms or like of the devices (400), (500). On this basis, the said analysis module matches with predefined parameter required.

In one embodiment of the present invention, the said system (1000) further includes file remove module. The file remove module activates and updates the said promotion media content in said module to remove the file.

In one embodiment of the present invention, the said system (1000) further includes media/multimedia calling dialer. In the embodiment, automatic module activates and calls plurality of users. As soon the users receive or disconnect the call, the information related to promotion media content may be updated in the said memory unit (302).

In one embodiment of the present invention, the system (1000) further includes user registration module. In the said user registration module, the user downloads the said predefined application (300) on devices (400), (500) and registers his mobile number and name on the said application (300) and creates a user panel.

The said user panel includes plurality of information related to the said promotion media content and user.

In one embodiment of the present invention, the system (1000) further includes intelligent user profile updating module. The said intelligent user profile updating module updates the user profile automatically as per the user's pre-selected choices.

In one embodiment of the present invention, the system (1000) further includes Service provider panel. The service provider will forward the information related to the plurality of promotion media contents

In one embodiment of the present invention, the system (1000) further includes intelligent user profile matching module. The said intelligent user profile matching module helps the service provider to identify the number of users with respect to the content/service/product that is uploaded by the service provider.

Further, the intelligent user profile matching module helps in categorizing the number of users in respect of the content/service/product. Furthermore, the intelligent user profile matching module helps in categorizing the users as per their location. Such kind of filtration and categorization helps the service provider to get the right users.

In one embodiment of the present invention, the system (1000) further includes auto download module. The content is downloaded in the devices (400), (500) via auto download module, whenever the internet is active on the user's mobile.

In one embodiment of the present invention, the system (1000) further includes content adjustment module. The said content adjustment module adjusts the downloaded content as per content type.

In one embodiment of the present invention, the said system (1000) further includes a transaction verification module. In the said embodiment, the database (102) sends all the transactions/details to the said transaction verification module to verify the details.

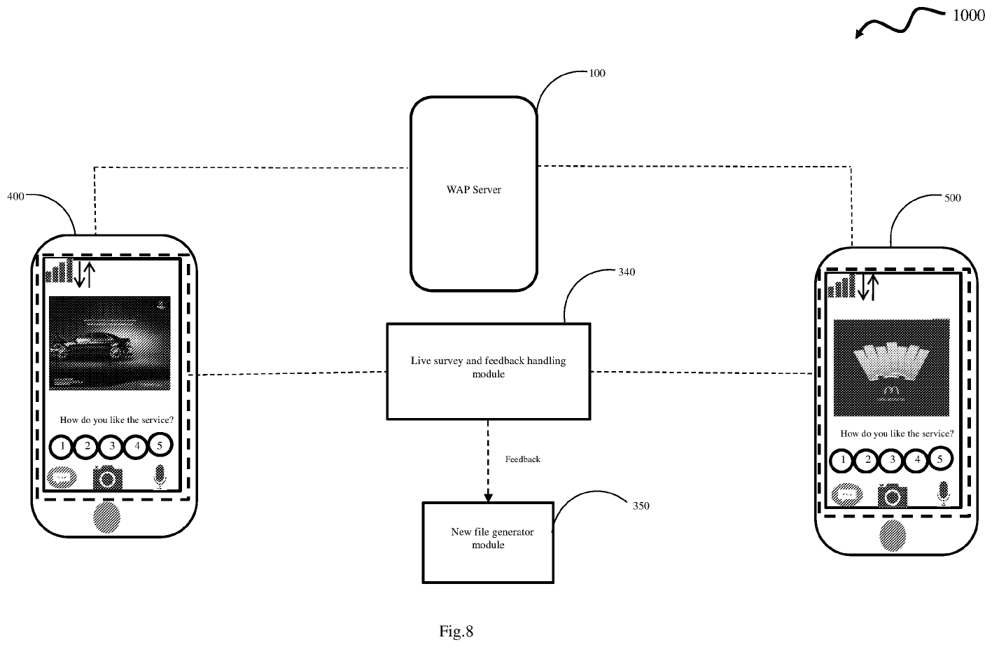

In one embodiment of the present invention, the said system (1000) further includes live survey and feedback handling module (340). The said live audio survey and feedback handling module (340) is adapted to take feedback of the said services or the plurality of promotion media contents or the like (refer FIG. 8).

In the said embodiment of the preset invention, whenever the user wants to use the live survey and feedback module (340), the user will first connect the caller device (400)/callee device (500) with internet. Further, the user activates the live audio survey and feedback handling module (340).

Subsequently, a server (100) will be connected to the live audio survey and feedback handling module (340). The said live audio survey and feedback handling module (340) will then activate the performing module and the performing module sends the last updated promotion media content from the auto uploading module to the playing module. The playing module will play the audio content on the screen of the user's mobile and activate audio recording module.

In the said embodiment of the present invention, the audio content includes multiple questions. Accordingly, the user answers the multiple questions by using touch pad/buttons or through voice commands/response. When this task ends, the audio detecting module detects the responses and sends the response to the new file generator module (350) (refer FIG. 8).

In the embodiment, the feedback is taken via capturing video of the user. In the other words, video based feedback can also be provided by the user through the camera of the devices (400), (500) (refer FIG. 8).

In yet another embodiment, the feedback can be entered in text form by using the touch button of the devices (400), (500) (refer FIG. 8).

In one embodiment of the present invention, the said system (1000) further includes new file generator module (350). The said new file generator module (350) receives the responses/feedback and save the response file with a new name.

In one embodiment of the present invention, the said system (1000) further includes a modem, a service/product information uploading electronic device, a call handling module, an audio/video/text detecting module, an editing and recording module, a new file generator module, a keypad detecting and working module, a service number auto dialing module, a survey and feedback module; a screen lock opening module, a ring signal lock capturing module, and a ring signal lock verification module.

In one embodiment of the present invention, the said devices (400), (500) include Normal Phones (Non GPRS and Non 3G/4G/5G). Accordingly, the promotion media content for the said normal phones is in form of at least one of SMS text advertisement, Scrolling text, Screen saver, Voice message, Background advertisement, Precall ads, Caller tune or Dialer ads.

In another embodiment of the present invention, the said devices (400), (500) include advance Phones or smart phones (with GPRS and 3G/4G/5G technologies). Accordingly, the promotion media content for the said advance phones is in form of at least one of Caller Ring Back Tone, Customized Caller Tone, Customized Video Caller Tone, Video Ring Back Tone, Video Ring Tone, Ring Tone, Pre-Call Audio Message, Dialer Call, During Call in Conference, Video Message, Wallpaper (Fixed or Sliding), Audio Message, Screen Saver, Scrolling Text, Dialer based IVRS Call, Text Message, Multimedia Messages, 3G/4G Video, SMS, MMS, Background music, Hyperlinks, Search Engine, Banner, Mobile Key Pad, Service message LBS (Location Based Service), USSD Message or Voice message.

In one embodiment of the present invention, the users will be classified into two categories, first one is registered user second one is unregistered users. The registered users will provide their complete details to the service provider and at any moment they can update their details as well as user categories or service provider can ask for the categories.

In the embodiment of the present invention, the registered members will be rewarded with credit points for reading listening of the plurality of promotion media contents and get benefit of rewarded points at any moment. Whereas the unregistered members can avail the benefits of promotion contents services, and will get rewarded for some credit points for using the said services, but unregistered user will get benefit of rewarded points after registration.

Therefore, with such facilities the present invention would be beneficial for companies, general consumer and government, as well.

### Beneficial for Companies

1. Large sale of product in less time.
2. Advertisement will be available to particular user on the basis of interested area.
3. It would be inexpensive and best.
4. Large production, due to fewer prices.
5. Facilities will provide according to particular area.
6. Direct contact with the customer is possible.
7. Small & new generate companies will grow in very short time.
8. In short duration and with less expense product will sale with high speed.

### Beneficial for General Consumer

1. User will get particular advertisement of their benefits.
2. User can store particular advertisement of their use and take advantage in future.
3. User can directly come in contact of us.
4. User can easily aware regarding advertisement of their benefits.

### Beneficial for Government

1. Advertisement will available at low price, so that product cost will be less automatically.
2. Through the advertisement, public may get emergency news.

Finally, all such facilities enhance the use of the promotion media content and because of its fewer prices it get popular in shortest time.

Further, the plurality of promotion media contents may be categorized in different categories such as General Information, Meals like Vegetarian/Non-Vegetarian & Other Habits like Drink, Assets, Real Estate, Learning & Reading, Finance & Investment and Insurance and so on. These categories are divided into sub-categories according to Area, Location, Sex, Age, Profession, Marital status, Hobbies, Books, Magazines, Newspaper, charity, real estate, banks, insurance, Medicines, sports, and Travel and Tourism. As we have to provide this service to the consumer. So the classification of categories is as such
Age-wise
Location-wise
Sex-wise
Hobbies-wise
Status-wise

### The Classification of Main Categories is as Such

General Information: Occupation, age, sex, income, location, marital status, health, interested areas, Hobbies, dressing, pets & animals
Food & Other Habits: Food Habits, drinks, alcoholic, smoker.
Property: House, Vehicle, Computer, Servant, Appliances, Technology.
Reading: Books, magazines, Newspaper
Finance & Investment: Charity, Real Estate, Insurance, Banks, Investment, Bank cards.
Others: Medicines, Sports & Fitness, travel & tourism.
   All these mention categories consist of sub-categories and each individual category has further division as follows:

### General Information:

Occupation: Business, Professionals, Service person student, student as well Professional
Age: Teenager, adult, senior citizen
Sex: male, female
Income: Monthly Income, Annual Income
Location: Rural, Urban, metropolitan
Marital status: Single, Married, Divorcee
Health: Healthy, patient, Fit
Interested Areas: Music, entertainment, Reading Books, travelling, outdoors games, indoor games
Hobbies: Music, reading, surfing, watching TV, sports, indoor games, video games, cycling swimming
Dressing: western, traditional, ethnic, readymade, custom made, formal, casual Pets & animals: Dog, cats, birds, others

### Food & Other Habits:

Food Habits: Vegetarian, Non-Vegetarian, Fast Food/Junk Food, Homemade, Eat Out, Snacks
Drinks: Fruit Juice, Health Drinks, Soft Drinks, Cold Drinks, Supplements, Shakes, Tea, Coffee
Alcoholic: Liquor, Wine, Beer, Others, Champaign, Vodka, Rum, Whisky, Tequila, Gin
Smoker: Smoking, Non-Smoking

### Property:

House: Rented, Owned, PG
Vehicle: 2 Wheeler, 4 Wheeler, Commercial Vehicle, None
Computer: Desktop, Laptop, Palm Top
Servant: Maid, Servant, Housemaid, Watchman, Driver, Gardener, Peon
Appliances: TV, Refrigerator, Microwave OTG, AC, Room Heater, Vacuum Cleaner, Dish Washer, Washing Machine, Iron
Technology: Internet, Mobile Phone, DTH Service

### Reading:

Books: Craft, Literature, History, Educational, Stories, Comics, Religious Books
Magazines: News, Sports, Automotive, Real Estate, Beauty, Current Events, Computers, Politics, Competitive, Interior Decoration, Jewelry, Fashion & Apparel
Newspaper: English, Hindi, Punjabi, Urdu, Bengali, Gujarati, Others

### Finance & Investment:

Charity: Old age Home, Orphanage, Widow Home, NGO, Social Services, CRY
Real Estate: Property, Flats, Apartment, Farm House, Home, Shop
Insurance: Death Accidental, Dismemberment Insurance, LIC
Banks: Private, Government, Corporate
Investment: Shares, Mutual Funds, Pension Plans, Stocks, Loans
Bank Cards: Credit Cards, ATM Cards, Debit Cards, Cash Cards, Travelers Cheque.

### Others:

Medicines: Veterinary Medicines, Acupuncture, Homeopathic, Ayurveda, Naturopathic, Allopathic.
Sports & fitness: Physical Fitness, Yoga, Gym, Aerobics.
Travel & Tourism: Airlines, Trains, Roadways, Taxi, Personal Vehicle.

Therefore, in the present invention the user from calling side and the user from receiving side, both can hear the customized promotion media content, as per their own desire.

Further, the present invention also provides interactive services, value added services and enhances the telephonic communication device feature.

Further, the promotion media content can be played not only during the ringing phase but also during telephonic conversation between the users and after disconnecting the call between the users.

Furthermore, the present invention provides playing of the promotion media connect by utilizing the call ring signal.

Therefore, the present invention is a system and a method of playing promotion media content in a telecommunication network, which is feasible, effective, and efficient as compared to existing methods.

The foregoing descriptions of specific embodiments of the present invention have been presented for purposes of description. They are not intended to be exhaustive or to limit the present invention to the precise forms disclosed, and obviously many modifications and variations are possible in light of the above teaching.

Further, the embodiments were chosen and described in order to best explain the principles of the present invention and its practical application, and thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

1. A method of playing promotion media content in a telecommunication network comprising plurality of mobile communication terminals with a caller device (400) capable of calling a callee device (500), the said method comprising:
storing a plurality of promotion media content on a database (102) of a Wireless application protocol (WAP) server (100);
receiving said promotion media content on a memory unit (302) of the caller device (400) and the callee device (500);
receiving incoming call signals from the caller device (400), the said incoming call signals being generated by dialing the callee number; and
outputting the said promotion media content by a predefined application on the said caller device (400) and the said callee device (500),
characterized in that,
the said predefined application (300) indicates a situation when the promotion media content is to be played, the said situation being at least one of when the caller device (400) commencing a call to the said callee device (500), during telephonic conversation between the said caller device (400) and the said callee device (500), and after disconnecting of the said call between the said caller device (400) and the said callee device (500),the said promotion media content being played by detecting at least one signal from plurality of telephony signals via a signal detecting module (260) on a screen of the at least one caller device (400) or callee device (500).

2. The method as claimed in claim 1, wherein the said promotion media content is selected from at least one of video, audio message, screen saver, scrolling text, multimedia, background music, video, and display banners.

3. The method as claimed in claim 1 comprising identifying a plurality of information, wherein the said plurality of information comprises information of the users, the promotion media content, updated promotion media status of the caller device (400) and the callee device (500), and time of usage of the said promotion media content of each of the caller device (400) and the callee device (500).

4. The method as claimed in claim 1, wherein playing the said promotion media content by incoming call ring signal comprises,
activating incoming call ring signal detecting module (270),
capturing the said incoming call ring signal, and
playing the said promotion media content via playing module (290) on the callee device (500) of the user.

5. The method as claimed in claim 1, wherein the said playing promotion media content by outgoing call ring signal comprises,
activating outgoing call ring signal detecting module (280),
identifying the said outgoing call ring signal,
capturing the said outgoing call ring signal,
transferring the said call through mobile switch center (MSC) (320),
receiving the said outgoing call ring signal via receiving module, and
playing the said promotion media content via the said playing module (290) on the caller device (400) during the said telephonic conversation between the users.

6. The method as claimed in 1 comprising updating a location of at least one of service or product via location signal module (310) in a predefined radius in relation with the user, wherein the said at least one of service or product is selected by the user and the said at least one of service or product is related to the promotion media content.

7. The method as claimed in claim 1 comprising unlocking the said devices (400), (500) via unlock module, wherein the said device (400), (500) are unlocked for playing the said promotion media content on the said devices (400, 500).

8. The method as claimed in claim 1 comprising uploading details of the said promotion media content played in the devices (400), (500), wherein the said details of the said promotion media content is uploaded in the said database (102) via internet connection.

9. The method as claimed in claim 1, wherein receiving incoming call signals from the caller device (400) comprises,
capturing Caller Line Identity (CLI) of the caller device (400) and predetermined service number via call action module (220) of a call handler,
scanning the said database (102) via look up module (230),
retrieving the said plurality of information of the said database (102) via the said look up module (230), and
forwarding the said at least one information of the said plurality of information to the caller device (400) via forwarding module (240).

10. The method as claimed in claim 1, wherein the said promotion media content is being customized via a customization module (250), wherein the said promotion media content is based on a captured signal of the caller device (400) and the callee device (500).

11. The method as claimed in claim 1, wherein outputting of the said promotion media on the screen of at least one caller device (400) or callee device (500) is when the at least one caller device (400) or callee device (500) is in a speaker mode.

12. The method as claimed in claim 1 comprising taking feedback of at least one of services or the plurality of promotion media contents via live survey and feedback handling module (340), wherein the said feedback is taken from the user of the caller device (400) and the callee device (500).

13. The method as claimed in claim 12, wherein the taking feedback of at least one of services or the plurality of promotion media contents via live survey and feedback module handling (340) comprises,
connecting the said caller device (400) and the said callee device (500) with internet,
activating the said the live audio survey and feedback handling module (340),
connecting the WAP server (100) to the said live audio survey and feedback handling module (340),
activating performing module via the said live audio survey and feedback handling module (340),
sending last updated promotion media content via the said performing module to the said playing module (290),
playing an audio content on the screen of the said caller device (400) and callee device (500),
activating audio recording module via the said live audio survey and feedback handling module (340),
recording the said audio content via the said audio recording module,
providing the feedback of the user from the caller device (400) and the callee device (500),
detecting the feedback of the user via the audio detecting module,
sending the said feedback to the said new file generating module (350), and
saving the said feedback via the said new file generating module (350).

14. The method as claimed in claim 13, wherein the said feedback is in form of at least one of audio, video or text.

15. A system (1000) for playing promotion media content in a telecommunication network comprising plurality of mobile communication terminals with a caller device (400) capable of calling a callee device (500), the said system (1000) comprising:
a Wireless application protocol (WAP) server (100) comprising,
a database (102) adapted to store plurality of promotion media content; and
a predefined application (300) downloaded on the caller device (400) and the callee device (500), the said predefined application (300) adapted to,
receive the said promotion media content in a memory unit (302) associated with the said predefined application (300) from the said database (102) of the said WAP server (100), and
output said promotion media content on the said caller device (400) and the callee device (500), characterized in that,
the said predefined application (300) indicates a situation when the said promotion media content is to be played, the said situation is being at least one of when the caller device (400) commencing a call to the said callee device (500), during telephonic conversation between the said caller device (400) and the said callee device (500), and after disconnecting of the said call between the said caller device (400) and the said callee device (500), and wherein the said promotion media content is played by detecting at least one signal from plurality of telephony signals via signal detecting module (260) on a screen of the at least one caller device (400) or callee device (500).

16. The system (1000) as claimed in claim 15, wherein the said promotion media content is selected from at least one of video, audio message, screen saver, scrolling text, multimedia, background music, video, and display banners.

17. The system (1000) as claimed in claim 15 comprises storing a plurality of information, the said plurality of information comprises information of the users, the information related to promotion media content, updated promotion media status of the caller device (400) and the callee device (500), time of usage of the said promotion media content of each of the caller device (400) and the callee device (500).

18. The system (1000) as claimed in claim 15 comprises an incoming call ring signal detecting module (270) adapted to detect incoming call ring signal, wherein the detection of the said incoming call ring signal is utilized to play the said promotion media content via playing module (290) on the said callee device (500) of the user.

19. The system (1000) as claimed in claim 15 comprises an outgoing call ring signal detecting module (280) adapted to detect outgoing call ring signal, wherein the detection of the said outgoing call ring signal is utilized to play the said promotion media content via the said playing module (290) on the said caller device (400) of the user.

20. The system (1000) as claimed in claim 15 comprises a location signal module (310) adapted to update a location of at least one of service or product in a predefined radius in relation with the user, wherein the said at least one of service or product is selected by the user, and the said at least one of service or product is related to the promotion media contents.

21. The system (1000) as claimed in claim 15 comprises unlock module adapted to unlock the caller device (400) of the user, wherein the said devices (400), (500) are unlocked to play the said promotion media content on the said devices (400), (500).

22. The system (1000) as claimed in claim 15 adapted to upload details of the promotion media content played in the devices (400), (500), wherein the said details of the said promotion media content is uploaded in the said data base (102) via internet connection.

23. The system (1000) as claimed in claim 15 comprises,
a call action module (220) adapted to,
capture a Caller Line Identity (CLI) of the caller device (400) and a predetermined service number,
a look up module (230) adapted to,
scan the said database (102) having plurality of information, and
retrieve the said plurality of information, and
a call forwarding module (240) communicably connected to the said look up module (230), the said call forwarding module is adapted to forward the at least one information to the caller device (400).

24. The system (1000) as claimed in claim 15 comprising a customization module (250) for customizing the said promotion media content, wherein the said promotion media content is based on a captured signal of the caller device (400) and the callee device (500).

25. The system (1000) as claimed in claim 15, wherein outputting of the said promotion media on the screen of at least one caller device (400) or callee device (500) is when the at least one caller device (400) or callee device (500) is in a speaker mode.

26. The system (1000) as claimed in claim 15 comprises live survey and feedback handling module (340), wherein the said live survey and feedback handling module (340) is adapted to take feedback of at least one of services or the plurality of promotion media contents from the said user of the caller device (400) and the callee device (500).

27. The system (1000) as claimed in claim 26 adapted to,
connect the said caller device (400) and the said callee device (500) with internet,
activate the said live audio survey and feedback handling module (340),
connect the WAP server (100) to the said live audio survey and feedback handling module (340),
activate performing module via the said live audio survey and feedback handling module (340),
send last updated promotion media content via the said performing module to the said playing module (290),
play an audio content on the screen of the said caller device (400) and callee device (500),
activate audio recording module via the said live audio survey and feedback handling module (340),
record the said audio content via the said audio recording module,
provide the feedback of the user from the caller device (400) and the callee device (500),
detect the feedback of the user via the audio detecting module,
send the said feedback to the said new file generating module (350), and
save the said feedback via the said new file generating module (350).

28. The system (1000) as claimed in claim 27, wherein the said feedback is in form of at least one of audio, video or text.
